(19) United States
(12) Patent Application Publication
(10) Pub. No.: US 2006/0156399 A1
(43) Pub. Date: Jul. 13, 2006

(54) System and method for implementing network security using a sequestered partition

(76) Inventors: Pankaj N. Parmar, Beaverton, OR (US); Saul Lewites, Aloha, OR (US); Ulhas Warrier, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,253

(22) Filed: Dec. 30, 2004

(51) Int. Cl. G06F 12/14

(52) U.S. Cl. 726/22

(57) ABSTRACT

A system and method are implemented within a computing system to perform tamper-resistant network security operations. For example, a method of one embodiment comprises: sequestering a partition on the computing system, the partition including a region of memory and a logical or physical processing element; forwarding incoming and/or outgoing data traffic through the sequestered portion, the incoming data traffic being received by the computing system from a network and the outgoing data traffic being transmitted from the computing system over the network; performing one or more security operations on the data traffic within the sequestered partition.

### BACKGROUND

1. Field of the Invention

This invention relates generally to the field of data processing systems. More particularly, the invention relates to a system and method for providing tamper-resistant network security within a computer system.

2. Description of the Related Art

Computer security is one of the burning issues that corporations around the world face today. Security breaches have caused billions of dollars worth of losses as a result of attacks caused by viruses, worms, trojan horses, data theft via computer system break-ins, buffer overflow problems and various additional types of computer threats. A variety of products employing a wide range of features and complexity are available today, but none of them offers a complete solution.

Many security-related problems are due to memory corruption. As such, the software-based security products that run on desktops and servers are vulnerable. For example, viruses are capable of modifying the program code of an infected program and may corrupt the data buffers/blocks used by the program. There is no way for a program to monitor/protect its own code/data, unless underlying support exists in the hardware of the computer system.

What is needed, therefore is a hardware-based security mechanism which is more robust and reliable than that provided with current systems.

### BRIEF DESCRIPTION OF THE DRAWINGS

A better understanding of the present invention can be obtained from the following detailed description in conjunction with the following drawings, in which:

FIG. 1 illustrates one embodiment of the invention which includes an OS partition and a sequestered partition.

FIG. 2 illustrates one embodiment of the invention which includes a process for establishing communication between an OS partition and a sequestered partition.

FIG. 3 illustrates one embodiment of a sequestered partition which implements network security operations.

FIG. 4 illustrates one embodiment of a process for analyzing and filtering outgoing network traffic from a computing system.

FIG. 5 illustrates one embodiment of a process for analyzing and filtering incoming network traffic to a computing system.

### DETAILED DESCRIPTION OF PREFERRED EMBODIMENTS

Described below is a system and method for implementing network security using a sequestered partition. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### Establishing Communication Between an Operating System and a Secure Partition

One embodiment of the invention is implemented within the context of a physical CPU in a multiprocessor system or a logical CPU i.e. a hyper-thread of a HT enabled CPU or a core of a multi-core CPU in a single or multiprocessor environment. Hyper-threading refers to a feature of certain CPUs (such as the Pentium® 4 designed by Intel) that makes one physical CPU appear as two logical CPUs to the operating system (“OS”). It uses a variety of CPU architectural enhancements to overlap two instruction streams, thereby achieving a significant gain in performance. For example, it allows certain resources to be duplicated and/or shared (e.g., shared registers). Operating systems may take advantage of the hyper-threaded hardware as they would on any multi-processor or multi-core CPU system.

Although the embodiments of the invention described below focus on a hyper-threaded implementation, the underlying principles of the invention are not limited to such an implementation. By way of example, and not limitation, the underlying principles of the invention may also be implemented within a multi-processor or multi-core CPU system.

In addition, in one embodiment, the techniques described herein are implemented within an Extended Firmware Interface (“EFI”)-compliant computer platform. EFI is a specification that defines the interface between a computer's firmware (commonly referred to as the “Basic Input Output System” or “BIOS”) and the OS. The interface consists of data tables that contain platform-related information, as well as boot and runtime service calls that are available to the operating system and its loader. Together, these provide a standard environment for booting an OS and running pre-boot applications. Although some of the embodiments described below are implemented within an EFI-compliant system, it should be noted that the underlying principles of the invention are not limited to any particular standard.

In one embodiment of the invention, prior to handling control over to the OS or the OS loader, the EFI sequesters a hyper-thread and a portion of the computer system's Random-Access Memory (“RAM”) for its use. The combination of the sequestered hyper-thread and RAM may be referred to herein as a “sequestered partition” or “S-Partition.” More generally, the S-Partition may include any set of system resources not accessible to the OS. By contrast, the “OS Partition” includes the OS itself and the computing resources made available to the OS.

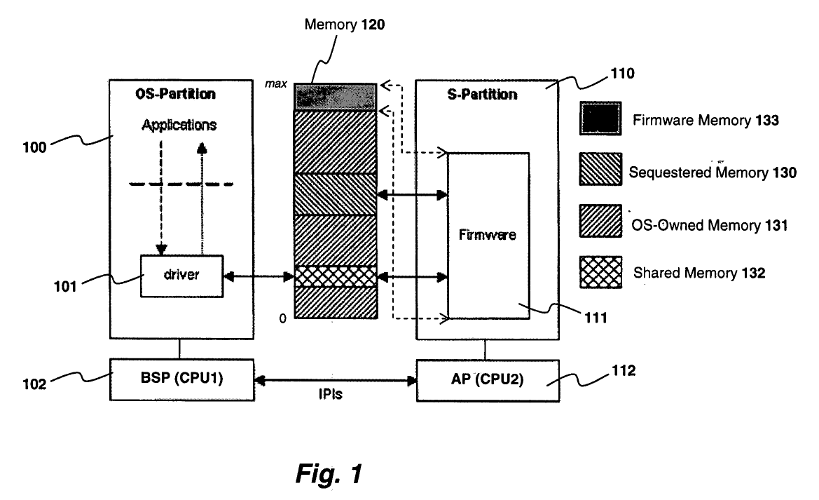

FIG. 1 illustrates an exemplary OS-Partition 100 communicating with an S-Partition through a shared block of memory 132 in a memory device 120. In one embodiment, the memory device is RAM or synchronous-dynamic RAM (“SDRAM”). The OS-Partition 100 includes the operating system, potentially one or more applications, a driver 101 to enable communication between the OS-Partition and the S-Partition via the shared memory and a hyper-thread CPU 102 (sometimes referred to herein as the bootstrap processor or “BSP”). The S-Partition 110 includes firmware 111 which, as mentioned above, may include EFI-compliant BIOS code, and a sequestered hyper-thread CPU 112 (sometimes referred to below as the application processor or “AP”). A particular region 133 of the memory may be used to store program code and/or data from the firmware 111. This block of memory 133 is initially shared but eventually becomes part of the sequestered memory after the OS boots and is not accessible/visible to the OS.

In one embodiment of the invention, the following set of operations are used to establish communication between the OS-Partition 100 and the S-Partition 110:

1. Sequester a Partition

To sequester a partition, a subset of the computer system's resources are segregated from the OS (i.e., set apart from the resources made visible to the OS). The partition may contain one or more physical CPUs or logical CPUs, or any combination thereof (e.g., a hyper-thread or other type of logically separable processing element), and enough RAM 130 to run the specialized program code described herein. Note that depending on the application one or more devices such as a Peripheral Component Interconnect (“PCI”) network adapter may also be included within the partition.

Sequestering of system resources is performed by the firmware 111 before the OS loads. For example, in one embodiment, RAM is sequestered by manipulating the physical memory map provided to the OS when the OS is booted up. More specifically, in one embodiment, a block of memory 130 is removed from the view of the OS by resizing or removing entries from the memory map. Moreover, in one embodiment, AP 112 (which may be a hyper-thread or a physically distinct CPU) is sequestered by modifying the Advanced Configuration and Power Interface (“ACPI”) table passed to the OS at boot time to exclude the ID of the sequestered AP 112 and its Advanced Programmable Interrupt Controller (“APIC”) from the table. For processors that support hyper-threading, concealing a physical core includes excluding both of its hyper-threads from the ACPI table.

2. Load Specialized Code on the Sequestered CPU and Boot the OS

During platform initialization, the firmware 111 is executed on a single logical CPU, i.e., the BSP 102. All other hyper-threads or cores are either halted or waiting for instructions. Prior to booting the OS, the CPU 102 indicates to the sequestered CPU, i.e., the AP 112 to start executing the specialized code which is pre-loaded into the sequestered block of RAM 130. In one embodiment, the specialized code waits for an OS-resident driver 101 to define the shared memory area 132, where data exchange between the two partitions 100, 110 will occur. The firmware 111 then disables all interrupts. In one embodiment, it does this by raising the task priority level (“TPL”) and loading the OS. Raising the TPL is typically as good as disabling the interrupts. This means while the OS is booting, it does not want to get interrupted by devices. Once the OS is ready to service interrupts, the TPL is restored.

3. Establish a Communication Link

As mentioned above, communication between the OS-Partition 100 and the S-Partition 110 is accomplished using a customized kernel driver 101. In one embodiment, the OS loads the driver 101 as a result of detecting a particular device on the PCI bus such as a network interface card (“NIC”), or through manual installation of a virtual device such as a virtual miniport. The former case involves replacing the NIC device's standard driver with a modified version that “talks” to the S-partition instead of talking directly to the NIC device. The latter case precludes the need for a physical device.

Once loaded, the driver registers an interrupt with the OS, extracts its interrupt vector, allocates a non-pageable shared region of memory 132, stores the interrupt vector in it, and marks the beginning of the segment with a unique multi-byte signature. In one embodiment, the specialized program code running on the AP 112 within the S-Partition 110 continuously scans the memory 120 for this signature. Once found, it extracts the interrupt vector of the OS-resident driver 101 and stores its own interrupt vector to enable inter-partition communication.

In one embodiment, the signature is a 16 byte pattern, although the underlying principles are not limited to any particular byte length or pattern. Scanning is performed by first reading bytes 0-15 and comparing them to the previously agreed-upon pattern. If the matching fails, bytes 1-16 are read and compared, then 2-17, etc. In one embodiment, to make the search more efficient, single instruction multiple data (“SIMD”) instructions are used for the comparison. More specifically, Single SIMD Extension 3 (“SSE3”) instructions and extended multimedia (“XMM”) registers may be used which allow the comparison of 16 byte arrays in a single instruction (e.g., such as the PCMPEQW instruction).

4. Exchange Data:

Once the shared memory region 132 has been allocated and interrupt vectors have been swapped as described above, both partitions are ready to exchange information. The particular semantics of the inter-partition protocol depend on the particular application at hand. For instance, for network stack offloading (such as that described below), the shared memory area may be allocated into a transmit (Tx) and a receive (Rx) ring of buffers. Signaling may be a accomplished through inter-processor interrupts (“IPIs”) using the initial exchange of interrupt vectors, or via polling, in which case one or both sides monitor a particular memory location to determine data readiness.

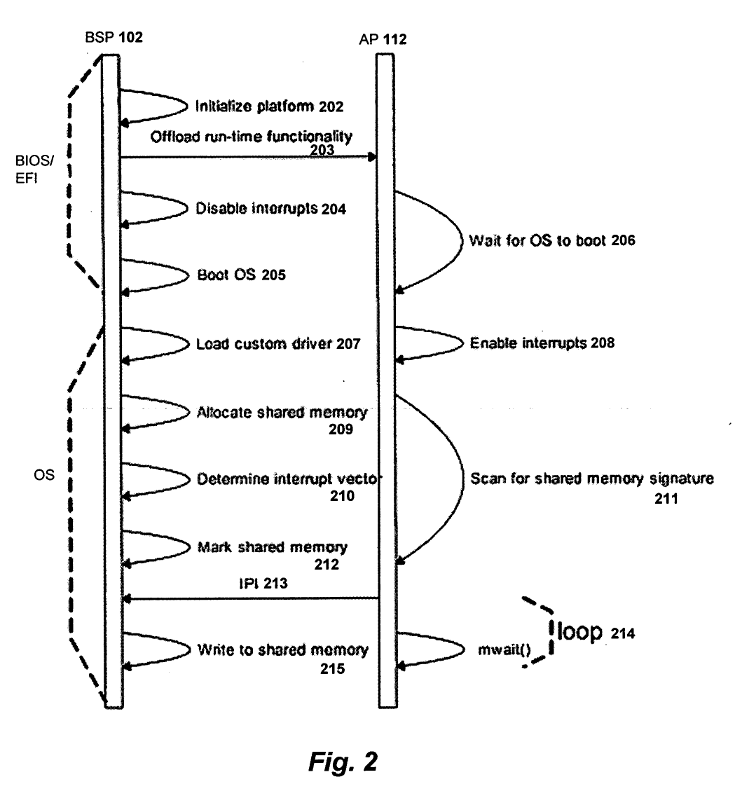

The timing diagram illustrated in FIG. 2 depicts the interaction between the BSP 102 and the AP 112 that leads to the exchange of data between the OS and the S-Partition. In this example, the specialized code in the S-Partition sends IPIs to the OS and monitors memory writes to the shared area with the mwait instruction. The mwait instruction is a known SSE3 instruction used in combination with the monitor instruction for thread synchronization. The mwait instruction puts the processor into a special low-power/optimized state until a store, to any byte in the address range being monitored, is detected, or if there is an interrupt, exception, or fault that needs to be handled. In one embodiemnt, the S-partition sends an IPI to the OS to indicate data post processing. The OS writes to the memory range on which the S-partition is waiting (via the mwait instruction) to indicate data to be processed. A write operation causes the S-partition to break out of the blocking mwait instruction and continue processing the data. Thus, the sequestered AP 112 provides an isolated execution environment and the monitor/mwait instructions are used to implement the signaling mechanism between the S-partition 110 and the OS-Partition 100.

At 202, the BSP initializes the platform by performing basic BIOS operations (e.g., testing memory, etc). At 203, the BSP offloads runtime functionality by sequestering system resources as described above. For example, the BSP may remove entries from the memory map to sequester a block of memory and sequester the AP from the OS-Partition as described above. At 204, the BSP disables all interrupts (e.g., by raising the task priority level (“TPL”)) and at 205 the BSP boots the OS. At 206, the AP waits for the OS to boot. At 207, the BSP loads the custom driver 101 which, at 209, allocates the shared memory region 132. At 208, the AP enables interrupts so that it may communicate with the BSP using IPIs and, at 211, begins to scan the shared memory region for the unique byte pattern. At 210 the BSP determines the interrupt vector to be exchanged with the AP and stores it in shared memory. At 212, the BSP marks the shared memory with the unique pattern, which is then identified by the AP via the scanning process 211. At this stage the AP may communicate with and send IPIs to the BSP. The AP enters into a loop at 214 in which it waits for the BSP to write to shared memory. In one embodiment, this is accomplished with the monitor/mwait instructions mentioned above. The BSP writes to shared memory at 215 and the data is accessed by the AP.

In sum, using the techniques described above, an additional, isolated execution environment is provided and monitor/mwait instructions are used to implement the signaling mechanism between the S-partition and the OS.

### System and Method for Implementing Network Security using a Sequestered Partition

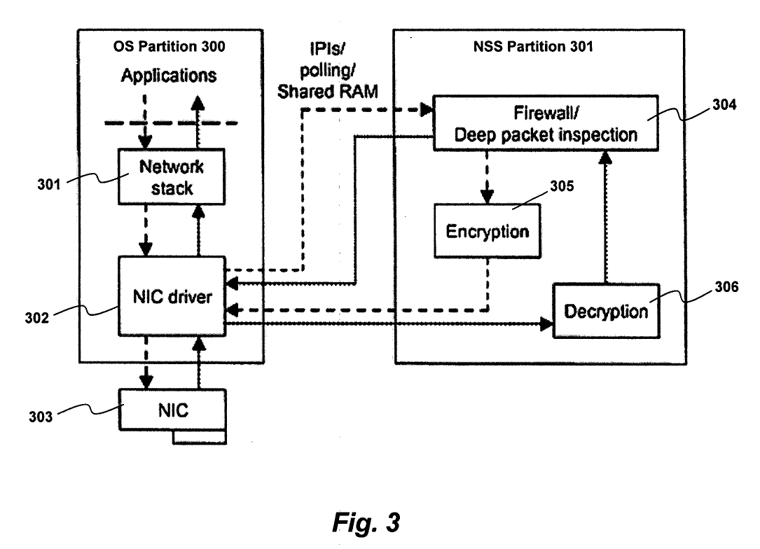

In one embodiment, the foregoing inter-partition communication techniques are used to provide a network security subsystem in an isolated, tamper-proof and secure environment. Specifically, one embodiment of the invention diverts incoming and outgoing data packets/frames to a network security subsystem (“NSS”) running within the context of the sequestered partition/CPU. Specifically, in one embodiment illustrated in FIG. 3 a modified NIC driver 302 forwards all received or transmitted packets/frames to a network security system (“NSS”) partition 301. The NSS partition 301 is a sequestered partition such as that described above with respect to FIG. 1. Thus, a “bump” is created in the traditional network stack. The NSS decrypts incoming data traffic via a decryption module 306 and encrypts outgoing data traffic via an encryption module 306. Various types of data cryptography standards may be employed while still complying with the underlying principles of the invention (e.g., IP Security (“IPSec”), Secure Sockets Layer (“SSL”), etc).

In addition, one embodiment of the NSS partition includes a firewall/deep packet inspection module 304 (hereinafter “firewall module 304”) which applies firewall, virtual private network (“VPN”), and/or admission control rules to the frames/packets. Various analysis and filtering techniques may be implemented by the firewall module 304 while still complying with the underlying principles of the invention (e.g., filtering based on blacklists, type of content, virus detection, etc). The NSS partition 301 indicates to the NIC diver 302 when all rules have been applied. In one embodiment, this causes the NIC driver 302 to start acknowledging all processed received (Rx) packets/frames to the network stack 301 or send all (Tx) packets/frames out on the network via the NIC 303. Thus, using asynchronous communication mechanisms such as Inter Processor Interrupts (“IPIs”) the OS partition 300 and the NSS partition 301, interact with each other in a non-blocking fashion.

FIG. 3 illustrates how the flow of incoming and outgoing packets are processed using these bump-in-the stack techniques. In FIG. 3, outgoing data traffic shown via dashed lines is redirected by the NIC driver 302 to the NSS partition 301 for inspection and/or encryption. The NSS partition 301 notifies the NIC driver 302 after inspecting or otherwise processing all frames/packets (e.g., matching them against firewall rules and other policies). In one embodiment, frames/packets that do not meet the policies configured in the firewall module 304 are not marked for transmission. Similarly, the NIC driver 302 forwards all incoming data traffic, shown via the solid lines in FIG. 3, to the NSS partition 301 for decryption and inspection before reporting them to the protocol stack. Incoming frames that do no meet the firewall criteria or fail other restrictive policies are dropped/filtered before they reach the network stack 301 of the OS.

Signaling between the OS partition 300 and NSS partition 301 may use the same techniques described above in FIGS. 1 and 2. For example, in one embodiment, signaling may be performed through IPIs or polling of a shared memory region or a combination of both. The shared memory area used for data exchange and signaling is allocated by the NIC driver 302.

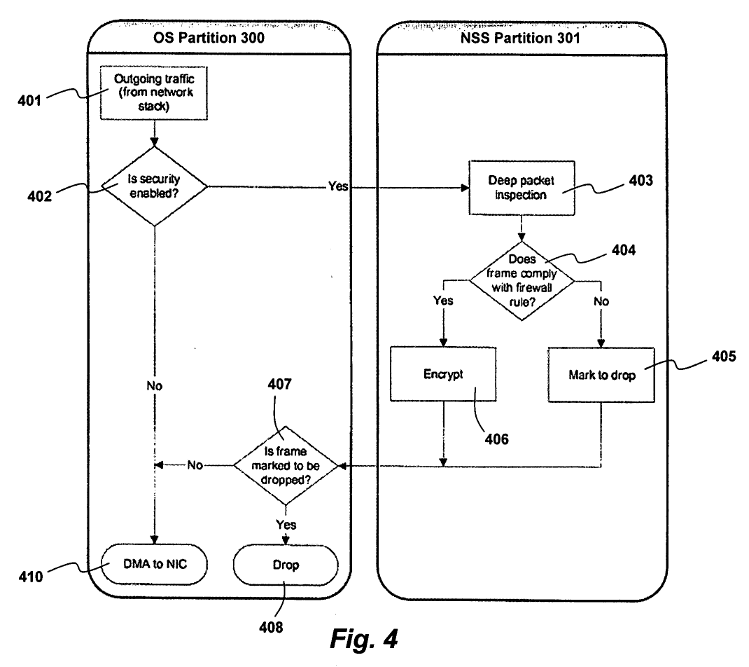

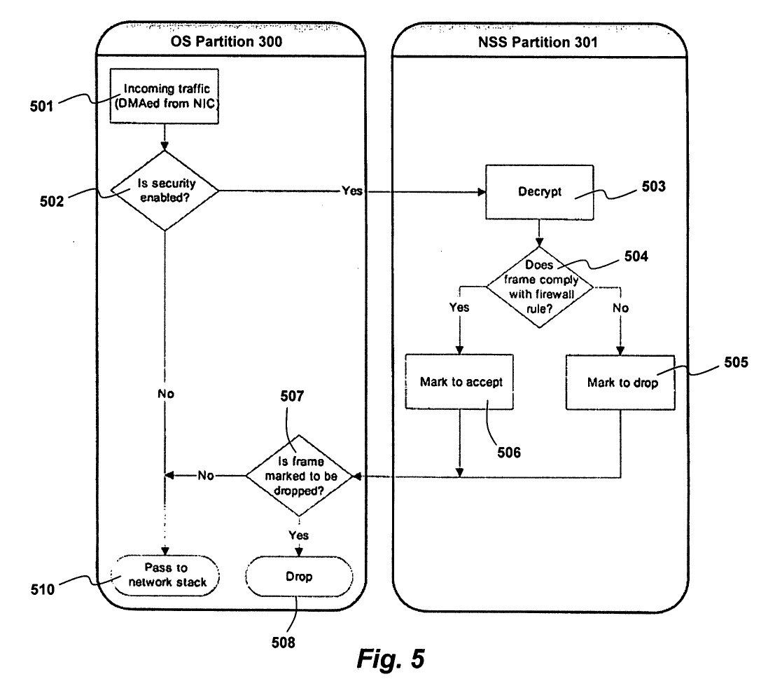

FIGS. 4 and 5 provide additional detail related to the processing of outgoing and incoming frames/packets, respectively, in the form of a flowchart. As mentioned above, the logical computing elements (e.g., CPU core, hyper-thread, etc.) assigned to each partition 300, 301 execute independently of each other. Each partition works on independent sets of packets/frames and communicates asynchronously with one another, thereby eliminating stalls or deadlocks. For example, while the NIC driver within the OS partition 300 is processing a set of packets/frames (e.g. creating/filling the buffer chain with packet headers, etc.) which have been approved by NSS partition 301 for acceptance, the NSS partition 301 may run firewall rules on a disjoint set of packets/frames. In other words, the two partitions employ a consumer/producer model in which one partition “produces” data and stores the data in shared memory and the other partition “consumes” the data from shared memory (and vice versa). As long as the allocated shared memory region 132 is large enough, no stalls or deadlocks will occur.

Referring now to FIG. 4, at 401, the OS partition 300 receives outgoing data traffic from the network stack and, at 402, determines whether the data traffic requires security. If not, then at 410, the data traffic is transmitted to the NIC (e.g., via a direct memory access (“DMA”) operation). If so, then at 403 the firewall module 304 performs an analysis of the data traffic by applying a set of packet/frame filtering rules against the data traffic. At 404, the firewall module 304 determines whether the data traffic complies with the set of firewall rules. If not, then at 405, the data traffic is marked to be dropped. After passing through the shared memory region 132, the OS partition 300 determines that the data traffic is marked to be dropped and drops the data traffic at 408. If the data traffic is not marked to be dropped (i.e., does not violate any of the firewall rules) then the data traffic is encrypted at 406 and, after passing through the shared memory region 132, is transmitted out over the network via the NIC.

Referring now to FIG. 5, at 501, the OS partition 300 receives data traffic from the NIC (e.g., via a DMA operation) and, at 502, determines whether the data traffic requires security. If not, then at 510, the data traffic is transmitted up the network stack 510 (e.g., to be processed by applications executed within the OS partition 300). If security is required then at 503 the data traffic is decrypted and at 504 is passed to the firewall module 304. The firewall module 304 performs an analysis of the data traffic by applying a set of packet/frame filtering rules against the data traffic (which may, or may not, be the same set of rules applied to the incoming data traffic in FIG. 4). At 504, the firewall module 304 determines whether the data traffic complies with the specified set of firewall rules. If not, then at 505, the data traffic is marked to be dropped. After passing through the shared memory region 132, the OS partition 300 determines that the data traffic is marked to be dropped at 507 and drops the data traffic at 508. If the data traffic is not marked to be dropped then, at 506, the data traffic is marked for acceptance and, at 510. is passed up the network stack for processing.

It should be noted that the network stack 301 illustrated in FIG. 3 may comply with a variety of different models including the Open System Interconnection (“OSI”) model. Moreover, the firewall module 304, the encryption module 305 and decryption module 306 may operate at various different levels of the OSI protocol stack while still complying with the underlying principles of the invention. For example, in one embodiment, these modules process filter TCP/IP packets at the transport layer (TCP) and/or network layer (IP). Alternatively, these modules may process frames such as Ethernet frames at the data-link layer. However, the underlying principles of the invention are not limited to any particular networking model or standard.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, a variety of different encryption/decryption and firewall protocols may be used to encrypt/decrypt and filter data traffic, respectively, while still complying with the underlying principles of the invention (e.g., layer 2 Extensible Authentication protocol (“EAP”)/802.1x, layer 3 Secure Sockets Layer (“SSL”)/Transport Layer Security (“TLS”), etc). In addition, the sequestered partition described herein may be configured to process data traffic at any layer of the OSI stack (e.g., data-link, network, transport, session, etc). Moreover, the underlying principles of the invention are not limited to any particular type of firewall/packet filtering processing.

In fact, the underlying inter-partition communication techniques described above with respect to FIGS. 1 and 2 may be used in a variety of different applications. By way of example, the sequestered program code may be an IT management application remotely accessible by IT personnel. Under certain conditions (e.g., if a virus or worm is propagating through computers on the network), it may be desirable to completely disable network traffic into and out of the computer on which the IT management application is sequestered. Upon receiving a particular message over the network, the sequestered IT management application will disable all data traffic (i.e., rather than merely filtering some of the data traffic as described above). By way of another example, a traffic control mechanism may be used to provision bandwidth into and out of the computer system (e.g., start dropping packets if data traffic exceeds 10 MBit/sec). Of course, these are merely a few examples of the many potential applications contemplated within the scope of the present invention.

Accordingly, the scope and spirit of the invention should be judged in terms of the claims which follow.

What is claimed is:

1. A method implemented within a computing system comprising:
sequestering a partition on the computing system, the partition including a region of memory and a logical or physical processing element;
forwarding incoming and/or outgoing data traffic through the sequestered portion, the incoming data traffic being received by the computing system from a network and the outgoing data traffic being transmitted from the computing system over the network;
performing one or more security operations on the data traffic within the sequestered partition.

2. The method as in claim 1 wherein the processing element comprises a hyper-thread.

3. The method as in claim 2 wherein the region of memory comprises a designated block of system memory.

4. The method as in claim 3 wherein the system memory comprises random access memory (“RAM”).

5. The method as in claim 1 wherein one of the security operations comprises analyzing the data traffic according to a plurality of rules to determine whether the data traffic should be transmitted over the network and/or into the computing system.

6. The method as in claim 5 wherein one of the security operations comprises encrypting and/or decrypting the data traffic.

7. The method as in claim 1 wherein sequestering a partition comprises making the region of memory and/or the logical or physical processing element inaccessible to the computing system's operating system.

8. The method as in claim 1 wherein forwarding incoming and/or outgoing data traffic through the sequestered portion comprises:
storing the data traffic in a memory region shared by the sequestered partition and the operating system of the computing system (“shared memory region”), the sequestered partition reading the data traffic from the shared memory region, performing the one or more security operations on the data traffic to create secure data traffic and storing the secure data traffic back to the shared memory region, the operating system reading the data from the shared region.

9. A system comprising:
a sequestered partition on a computing system, the sequestered partition including a region of memory and a logical or physical processing element;
a driver to forward incoming and/or outgoing data traffic through the sequestered portion, the incoming data traffic being received by the driver from a network and the outgoing data traffic being transmitted from the driver over the network;
security processing logic within the sequestered partition to perform one or more security operations on the data traffic.

10. The system as in claim 9 wherein the processing element comprises a hyper-thread.

11. The system as in claim 10 wherein the region of memory comprises a designated block of system memory.

12. The system as in claim 11 wherein the system memory comprises random access memory (“RAM”).

13. The system as in claim 9 wherein the security processing logic comprises a firewall module to analyze the data traffic according to a plurality of rules to determine whether the data traffic should be transmitted over the network and/or into the computing system.

14. The system as in claim 13 wherein the security processing logic further comprises an encryption and decryption module to encrypt and decrypt the data traffic, respectively.

15. The system as in claim 9 wherein the computing system includes an operating system and wherein sequestering a partition comprises making the region of memory and/or the logical or physical processing element inaccessible to the computing system's operating system.

16. The system as in claim 9 wherein forwarding incoming and/or outgoing data traffic through the sequestered portion comprises:
the driver storing the data traffic in a memory region shared by the sequestered partition and the driver (“shared memory region”), the sequestered partition reading the data traffic from the shared memory region, performing the one or more security operations on the data traffic to create secure data traffic and storing the secure data traffic back to the shared memory region, the driver reading the data from the shared region.

17. A machine-readable medium having program code stored thereon which, when executed by a machine, causes the machine to perform the operations of:
sequestering a partition on the computing system, the partition including a region of memory and a logical or physical processing element;
forwarding incoming and/or outgoing data traffic through the sequestered portion, the incoming data traffic being received by the computing system from a network and the outgoing data traffic being transmitted from the computing system over the network;
performing one or more security operations on the data traffic within the sequestered partition.

18. The machine-readable medium as in claim 17 wherein the processing element comprises a hyper-thread.

19. The machine-readable medium as in claim 18 wherein the region of memory comprises a designated block of system memory.

20. The machine-readable medium as in claim 19 wherein the system memory comprises random access memory (“RAM”).
